(19) United States
(12) Patent Application Publication
(10) Pub. No.: US 2008/0278939 A1
(43) Pub. Date: Nov. 13, 2008

(54) Light Source Device

(75) Inventor: Yoshiko Endo, Tochigi (JP)

Correspondence Address: GREENBLUM & BERNSTEIN, P.L.C., 1950 ROLAND CLARKE PLACE, RESTON, VA, 20191, US

(73) Assignee: ADVANTEST CORPORATION, Tokyo (JP)

(21) Appl. No.: 11/571,190

(22) PCT Filed: Jun. 21, 2005
(86) PCT No.: PCT/JP05/11698

§ 371 Date: Feb. 13, 2007

(30) Foreign Application Priority Data
Jun. 24, 2004 (JP) 2004-186631

(51) Int. Cl. F21V 13/00; F21V 9/00

(52) U.S. Cl. 362/231; 250/494.1

(57) ABSTRACT

There is provided a light source device which can output simultaneously a light in the C band and a light in the L band. The light source device includes a reflection end which reflects an input light, a first EDF which is connected at one end to the reflection end, and outputs a first spontaneously emitted light (C band) by means of a first excitation light input from the other end, a second EDF which is connected at one end to the other end of the first EDF, and outputs a second spontaneously emitted light (C band) by means of a second excitation light input from the other end, where the second EDF converts the first spontaneously emitted light (C band) input from the one end to a longer wavelength light (L band), and outputs the longer wavelength light. From the other end of the second EDF are output simultaneously the second spontaneously emitted light (C band) and the longer wavelength light (L band).

### TECHNICAL FIELD

The present invention relates to a light source which generates light across a broad band, and more particularly relates to a broad band light source which generates a light in the 1.55 μm band (C band), and a light in the 1.58 μm band (L band).

### BACKGROUND ART

There has conventionally been proposed a light source which generates a light in the 1.55 μm band (C band) and a light in the 1.58 μm band (L band) (patent document 1 (Japanese Laid-Open Patent Publication (Kokai No. 2001-358389), for example). For example, in the patent document 1, the light source can output the light in the C band, and the light in the L band.

However, the light source according to prior art cannot output simultaneously the light in the C band and the light in the L band.

The present invention has an object to provide a light source device which can output simultaneously the light in the C band and the light in the L band.

### DISCLOSURE OF INVENTION

According to the present invention, a light source device includes: a first spontaneously emitted light output unit that includes one end and the other end, and outputs a first spontaneously emitted light by means of a first excitation light input from the other end; a second spontaneously emitted light output unit that includes one end connected to the other end of the first spontaneously emitted light output unit, and outputs a second spontaneously emitted light by means of a second excitation light input from the other end, wherein the second spontaneously emitted light output unit converts the first spontaneously emitted light input from the one end to a longer wavelength light which has a longer wavelength, and outputs the longer wavelength light.

According to the thus constructed light source device, a first spontaneously emitted light output unit includes one end and the other end, and outputs a first spontaneously emitted light by means of a first excitation light input from the other end. A second spontaneously emitted light output unit includes one end connected to the other end of the first spontaneously emitted light output unit, and outputs a second spontaneously emitted light by means of a second excitation light input from the other end. Furthermore, the second spontaneously emitted light output unit converts the first spontaneously emitted light input from the one end to a longer wavelength light which has a longer wavelength, and outputs the longer wavelength light.

According to the present invention, the light source device may include a light reflection unit that is connected to the one end of the first spontaneously emitted light output unit, and reflects a light input from the one end to the one end.

According to the present invention, the light source device may include a non-reflection unit that is connected to the one end of the first spontaneously emitted light output unit, and does not return a light input from the one end to the one end.

According to the present invention, the light source device may include a reflection reduction unit that is connected to the one end of the first spontaneously emitted light output unit, and hardly returns a light input from the one end to the one end.

According to the light source device of the present invention, the first spontaneously emitted light and the second spontaneously emitted light may be within the C band, and the longer wavelength light may be within the L band.

According to the present invention, the light source device may include: an integrated output unit that outputs the second spontaneously emitted light and the longer wavelength light; a first excitation light generation unit that generates the first excitation light; a first connection unit that connects the first excitation light generation unit and the other end of the first spontaneously emitted light output unit with each other; a second excitation light generation unit that generates the second excitation light; and a second connection unit that connects the second excitation light generation unit and the other end of the second spontaneously emitted light output unit, and the integrated output unit, wherein the first connection unit leads the first excitation light to the other end of the first spontaneously emitted light output unit, and leads the first spontaneously emitted light to the one end of the second spontaneously emitted light output unit, and the second connection unit leads the second excitation light to the other end of the second spontaneously emitted light output unit, and leads the second spontaneously emitted light and the longer wavelength light to the integrated output unit.

According to the present invention, the light source device may include: an integrated output unit that outputs the second spontaneously emitted light and the longer wavelength light; an integrated excitation light generation unit that generates an integrated excitation light used as the first excitation light and the second excitation light; a first connection unit that connects the integrated excitation light generation unit and the other end of the first spontaneously emitted light output unit with each other; a second connection unit that connects the integrated excitation light generation unit and the other end of the second spontaneously emitted light output unit, and the integrated output unit, wherein the first connection unit leads the integrated excitation light as the first excitation light to the other end of the first spontaneously emitted light output unit, and leads the first spontaneously emitted light to the one end of the second spontaneously emitted light output unit, and the second connection unit leads the integrated excitation light as the second excitation light to the other end of the second spontaneously emitted light output unit, and leads the second spontaneously emitted light and the longer wavelength light to the integrated output unit.

According to the light source device of the present invention, the first connection unit may be connected to the integrated excitation light generation unit via the second connection unit.

According to the present invention, the light source device may include a third connection unit that connects the first connection unit, the second connection unit and the integrated excitation light generation unit.

According to the light source device of the present invention, the power of the second excitation light may be larger than the power of the first excitation light.

According to the light source device of the present invention, the ratio of the power P2 of the second excitation light to the power P1 of the first excitation light: P2/P1 may be 3.

According to the light source device of the present invention, the integrated output unit may include an isolator.

According to the light source device of the present invention, the second connection unit may lead the second spontaneously emitted light and the longer wavelength light only to the integrated output unit.

### BRIEF DESCRIPTION OF THE DRAWINGS

FIG. 1 is a diagram showing a configuration of a light source device 1 according a first embodiment of the present invention;

FIG. 2 is a diagram showing a configuration of a light source device 1 according to the second embodiment of the present invention;

FIG. 3 is a diagram showing a configuration of a light source device 1 according to the third embodiment of the present invention;

FIG. 4 is a diagram showing ratios of an output light and a returning light when one end 22a of a first EDF 22 is connected to an open end;

FIG. 5 is a diagram showing various non-reflection means isolator 12a, matching jell 12b, AR coating 12c, and obliquely polished end 12d); and

FIG. 6 is a diagram showing a reflection reduction means (optical attenuator 12e)

### BEST MODE FOR CARRYING OUT THE INVENTION

A description will now be given of embodiments of the present invention with reference to drawings.

### First Embodiment

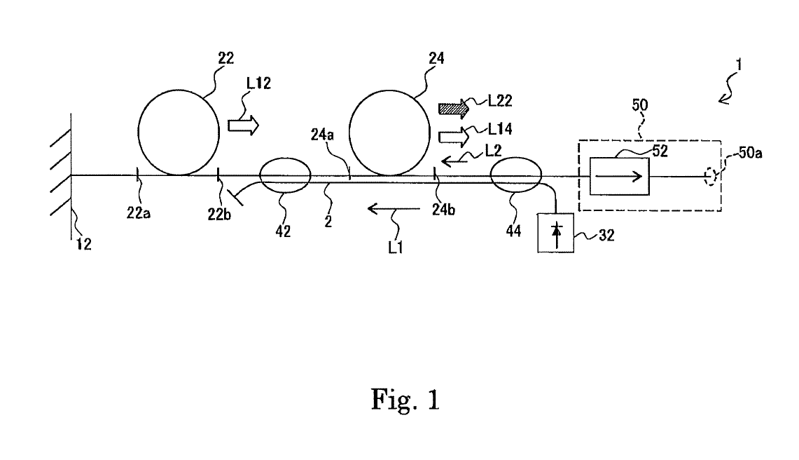

FIG. 1 is a diagram showing a configuration of a light source device 1 according a first embodiment of the present invention. The light source device 1 includes a reflection end (tight reflection means) 12, a first EDF (first spontaneously emitted light output means) 22, a second EDF (second spontaneously emitted light output means) 24, an integrated excitation light source 32, a first coupler (first connection means) 42, a second coupler (second connection means) 44, and integrated output means 50.

The reflection end (light reflection means) 12 reflects an input light. The reflection end 12 is a gold vapor deposition end, for example. The reflection end 12 should feed a light input from one end 22a of the first EDF 22 back to the one end 22a of the first EDF 22.

The first EDF (first spontaneously emitted light output means) 22 is an EDF Erbium-Doped Fiber). The one end 22a of the first EDF 22 is connected to the reflection end 12.

The second EDF (second spontaneously emitted light output means) 24 is an EDF (Erbium-Doped Fiber). One end 24a of the second EDF 24 is connected to the other end 22b of the first EDF 22.

The integrated excitation light source 32 is a light source which emits an integrated excitation light with a wavelength of 980 nm. The integrated excitation light is used as a first excitation light L1 input to the first EDF 22 and a second excitation light L2 input to the second EDF 24.

The integrated output means 50 receives a light output from the other end 24b of the second EDF 24, and outputs the received light to the outside of the light source device 1. The integrated output means 50 includes an isolator 52. The isolator 52 passes a light in a direction output from the other end 24b of the second EDF 24, and does not pass a light in a direction input to the other end 24b of the second EDF 24.

The second coupler (second connection means) 44 connects the other end 24b of the second EDF 24, the integrated excitation light source 32 and the integrated output means 50.

The second coupler 44 leads light (second spontaneously emitted light L14 and longer wavelength light L22) output from the other end 24b of the second EDF 24 only to the integrated output means 50. The second coupler 44 does not lead the light to the integrated excitation light source 32 and the first coupler 42.

Moreover, the second coupler 44 leads the integrated excitation light output from the integrated excitation light source 32 to the other end 24b of the second EDF 24 and the first coupler 42. A light of the integrated excitation light led to the first coupler 42 is the first excitation light L1, and a light thereof led to the other end 24b of the second EDF 24 is the second excitation light L2. If the power of the first excitation light L1 is represented as P1, and the power of the second excitation light L2 is represented as P2, it is assumed that P1<P2. Particularly, it is preferable that P1:P2=1:3 (P2/P1=3).

The first coupler (first connection means) 42 connects the integrated excitation light source 32 and the other end 22b of the first EDF 22 with each other. Specifically, the first coupler 42 is connected to the integrated excitation light source 32 via the second coupler 44. The first coupler 42 is connected to the second coupler 44 by a fiber 2. The fiber 2 is different from a fiber to which the first EDF 22 and the second EDF 24 are connected. It should be noted that the first coupler 42 can be used to connect the first EDF 22 and the second EDF 24 with each other.

The first coupler 42 leads the light (first spontaneously emitted light L12) output from the other end 22b of the first EDF 22 only to the one end 24a of the second EDF 24, and does not lead the light to the fiber 2. Moreover) the first coupler 42 leads the first excitation light L1 input via the fiber 2 only to the other end 22b of the first EDF 22, and does not lead the first excitation light L1 to the one end 24a of the second EDF 24. The first coupler 42 is a WDM coupler, for example.

A description will now be given of an operation of the first embodiment.

The integrated excitation light source 32 first outputs the integrated excitation light. The integrated excitation light is input to the second coupler 44. The integrated excitation light is divided into the first excitation light L1 and the second excitation light L2 by the second coupler 44. When the power of the first excitation light L1 is represented as P1, and the power of the second excitation light L2 is represented as P2, P1:P2=1:3 (P2/P=13), for example.

The first excitation light L1 is input to the first coupler 42 via the fiber 2. The first coupler 42 leads the first excitation light L1 only to the other end 22b of the first EDF 22. The first excitation light L1 is thus input to the first EDF 22. Erbium ions contained in the first EDF 22 are excited to a higher energy level by the first excitation light L1. ASE (Amplified Spontaneous Emission) light is generated when the excited erbium ions transit to a lower energy level. The ASE light is “Amplified Spontaneous Emission” light, and is a type of spontaneous emission light. On this occasion, the spontaneous emission light generated in the first EDF 22 is referred to as the first spontaneously emitted light L12. The wavelength band of the first spontaneously emitted light L12 is the 1.55 μm band (C band).

The first spontaneously emitted light L12 is output from the other end 22b of the first EDF 22, and is input to the first coupler 42. The first coupler 42 leads the first spontaneously emitted light L12 only to the one end 24a of the second EDF 24.

The second excitation light L2 is led only to the other end 24b of the second EDF 24. The second excitation light L2 is thus input to the second EDF 24. Erbium ions contained in the second EDF 24 are excited to a higher energy level by the second excitation light L2. ASE (Amplified Spontaneous Emission) light is generated when the excited erbium ions transit to a lower energy level. The ASE light is “Amplified Spontaneous Emission” light, and is a type of spontaneous emission light. On this occasion, the spontaneous emission light generated in the second EDF 24 is referred to as the second spontaneously emitted light L14. The wavelength band of the second spontaneously emitted light L14 is the 1.55 μm band (C band). The second spontaneously emitted light L14 is output from the other end 24b of the second EDF 24.

The first spontaneously emitted light L12 is output from the other end 22b of the first EDF 22, and to the first coupler 42. The first coupler 42 leads the first spontaneously emitted light L12 only to the one end 24a of the second EDF 24. The first spontaneously emitted light L12 is thus input to the second EDF 24. The second EDF 24 converts the input first spontaneously emitted light L12 into the longer wavelength light L22 with the longer wavelength, and outputs the longer wavelength light L22 from the other end 24b. The wavelength band of the longer wavelength light L22 is the 1.58 μm band (L band).

It should be noted that a part of the first spontaneously emitted light L12 may be output from the one end 22a of the first EDF 22. Moreover, a part of the second spontaneously emitted light L14 may be output from the one end 24a of the second EDF 24. The light progressing toward the reflection end 12 in this way are reflected by the reflection end 12, and are converted into the longer wavelength light L22 after passing through the first EDF 22 and the second EDF 24.

As described above, the second spontaneously emitted light L14 and the longer wavelength light L22 are output from the other end 24b of the second EDF 24. The second spontaneously emitted light L14 and the longer wavelength light L22 output from the other end 24b of the second EDF 24 are led only to the integrated output means 50 by the second coupler 44.

The integrated output means 50 outputs the second spontaneously emitted light L14 and the longer wavelength light L22 to the outside of the light source device 1. A part of the second spontaneously emitted light L14 and the longer wavelength light L22 is reflected by an output end 50a, and tends to return to the second coupler 44. However, the isolator 52 prevents such a reflected light from returning to the second coupler 44.

According to the first embodiment, the light source device 1 can simultaneously output the second spontaneously emitted light L14 (C band) and the longer wavelength light L22 (L band).

### Second Embodiment

The light source device 1 according to the second embodiment is different from the light source device 1 according to the first embodiment in that the first coupler 42 and the second coupler 44 are connected to the integrated excitation light source 32 via a third coupler 46.

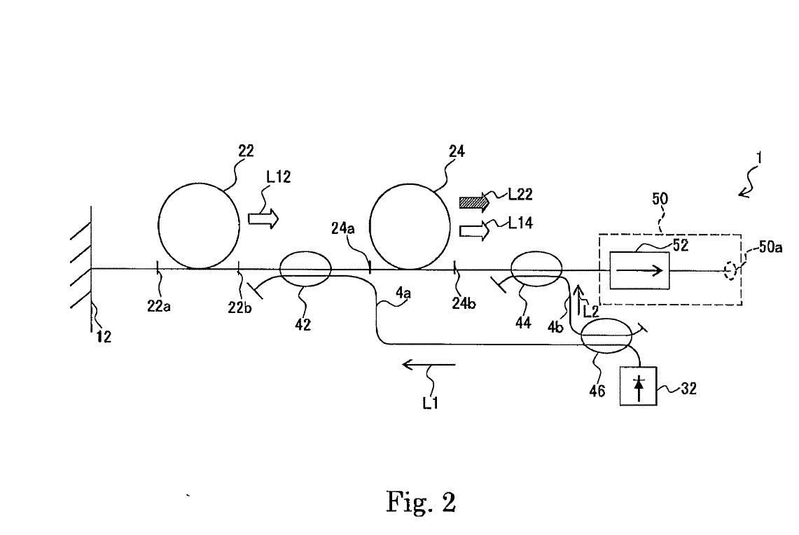

FIG. 2 is a diagram showing a configuration of the light source device 1 according to the second embodiment of the present invention. The light source device 1 according to the second embodiment includes the reflection end (light reflection means) 12, the first EDF (first spontaneously emitted light output means) 22, the second EDF (second spontaneously emitted light output means) 24, the integrated excitation light source 32, the first coupler (first connection means) 42, the second coupler (second connection means) 44, the third coupler (third connection means) 46, and the integrated output means 50. In the following section, similar components are denoted by the same numerals as of the first embodiment, and will be explained in no more details.

The reflection end (light reflection means) 12, the first EDF (first spontaneously emitted light output means) 22, the second EDF (second spontaneously emitted light output means) 24, the integrated excitation light source 32, and the integrated output means 50 are the same as those of the first embodiment, and will not be explained.

The third coupler (third connection means) 46 connects the first coupler 42, the second coupler 44 and the integrated excitation light source 32.

Moreover, the third coupler 46 leads the integrated excitation light output from the integrated excitation light source 32 to the first coupler 42 and the second coupler 44. Of the integrated excitation light, a light led to the first coupler 42 is to be the first excitation light L1, and a light led to the second coupler 44 is to be the second excitation light L2. If the power of the first excitation light L1 is represented as P1, and the power of the second excitation light L2 is represented as P2, it is assumed that P1<P2. Particularly, it is preferable that P1:P2=1:3 (P2/P1=3).

The first coupler 42 is approximately the same as that of the first embodiment, and a description will be given of differences. The first coupler 42 is connected to the integrated excitation light source 32 via the third coupler 46. The first coupler 42 is connected to the third coupler 46 by a fiber 4a. The fiber 4a is different from a fiber to which the first EDF 22 and the second EDF 24 are connected.

The first coupler 42 leads the light (first spontaneously emitted light L12) output from the other end 22b of the first EDF 22 only to the one end 24a of the second EDF 24, and does not lead the light to the fiber 4a. Moreover, the first coupler 42 leads the first excitation light L1 input via the fiber 4a only to the other end 22b of the first EDF 22, and does not lead the first excitation light L1 to the one end 24a of the second EDF 24. The first coupler 42 is a WDM coupler, for example.

The second coupler 44 is approximately the same as that of the first embodiment, and a description will be given of differences. The second coupler 44 is connected to the integrated excitation light source 32 via the third coupler 46. The second coupler 44 is connected to the third coupler 46 by a fiber 4b. The fiber 4b is different from the fiber to which the first EDF 22 and the second EDF 24 are connected.

The second coupler 44 leads the light (second spontaneously emitted light L14 and longer wavelength light L22) output from the other end 24b of the second EDF 24 only to the integrated output means 50. The second coupler 44 does not lead the light to the fiber 4b. Moreover, the second coupler 44 leads the second excitation light L2 input via the fiber 4b only to the other end 24b of the second EDF 24, and does not lead the second excitation light L2 to the integrated output means 50. The second coupler 44 is a WDM coupler, for example.

A description will now be given of an operation of the second embodiment.

The integrated excitation light source 32 first outputs the integrated excitation light. The integrated excitation light is input to the third coupler 46. The integrated excitation light is divided into the first excitation light L1 and the second excitation light L2 by the third coupler 46. When the power of the first exit light L1 is represented as P1, and the power of the second excitation light L2 is represented as P2, P1:P2=1:3 (P2/P1=3), for example.

The first excitation light L1 is input to the first coupler 42 via the fiber 4a. The first coupler 42 leads the first excitation light L1 only to the other end 22b of the first EDF 22. The first excitation light L1 is thus input to the first EDF 22. Erbium ions contained in the first EDF 22 are excited to a higher energy level by the first excitation light L1. ASE (Amplified Spontaneous Emmission) light is generated when the excited erbium ions transit to a lower energy level. The ASE light is “Amplified Spontaneous Emission” light, and is a type of spontaneous emission light. On this occasion, the spontaneous emission light generated in the first EDF 22 is referred to as the first spontaneously emitted light L12. The wavelength band of the first spontaneously emitted light L12 is the 1.55 μm band (C band).

The first spontaneously emitted light L12 is output from the other end 22b of the first EDF 22, and is input to the first coupler 42. The first coupler 42 leads the first spontaneously emitted light L12 only to the one end 24a of the second EDF 24.

The second excitation light L2 is input to the second coupler 44 via the fiber 4b. The second coupler 44 leads the second excitation light L2 only to the other end 24b of the second EDF 24. The second excitation light L2 is thus input to the second EDF 24. Erbium ions contained in the second EDF 24 are excited to a higher energy level by the second excitation light L2. ASE (Amplified Spontaneous Emission) light is generated when the excited erbium ions transit to a lower energy level. The ASE light is “Amplified Spontaneous Emission” light, and is a type of spontaneous emission light. On this occasion, the spontaneous emission light generated in the second EDF 24 is referred to as the second spontaneously emitted light L14. The wavelength band of the second spontaneously emitted light L14 is the 1.55 μm band (C band). The second spontaneously emitted light L14 is output from the other end 24b of the second EDF 24.

The first spontaneously emitted light L12 is output from the other end 22b of the first EDF 22, and is input to the first coupler 42. The first coupler 42 leads the first spontaneously emitted light L12 only to the one end 24a of the second EDF 24. The first spontaneously emitted light L12 is thus input to the second EDF 24. The second EDF 24 converts the input first spontaneously emitted light L12 into the longer wavelength light L22 with the longer wavelength, and outputs the converted light from the other end 24b. The wavelength band of the longer wavelength light L22 is the 1.58 μm band (L band).

It should be noted that a part of the first spontaneously emitted light L12 may be output from the one end 22a of the first EDF 22. Moreover, a part of the second spontaneously emitted light L14 may be output from the one end 24a of the second EDF 24. In this way, the light progressing toward the reflection end 12 are reflected by the reflection end 12, and are converted into the longer wavelength light L22 after passing through the first EDF 22 and the second EDF 24.

As described above, the second spontaneously emitted light L14 and the longer wavelength light L22 are output from the other end 24b of the second EDF 24. The second spontaneously emitted light L14 and the longer wavelength light L22 output from the other end 24b of the second EDF 24 are led only to the integrated output means 50 by the second coupler 44.

The integrated output means 50 outputs the second spontaneously emitted light L14 and the longer wavelength light L22 to the outside of the light source device 1. Apart of the second spontaneously emitted light L14 and the longer wavelength light L22 is reflected by the output end 50a, and tends to return to the second coupler 44. However, the isolator 52 prevents the reflected light from returning to the second coupler 44.

According to the second embodiment, the light source device 1 can simultaneously output the second spontaneously emitted light L14 (C band) and the longer wavelength light L22 (L band).

### Third Embodiment

The light source device 1 according to a third embodiment is different from the light source devices 1 according to the first and second embodiments in that there are provided a first excitation light source 34 and a second excitation light source 36 in place of the integrated excitation light source 32.

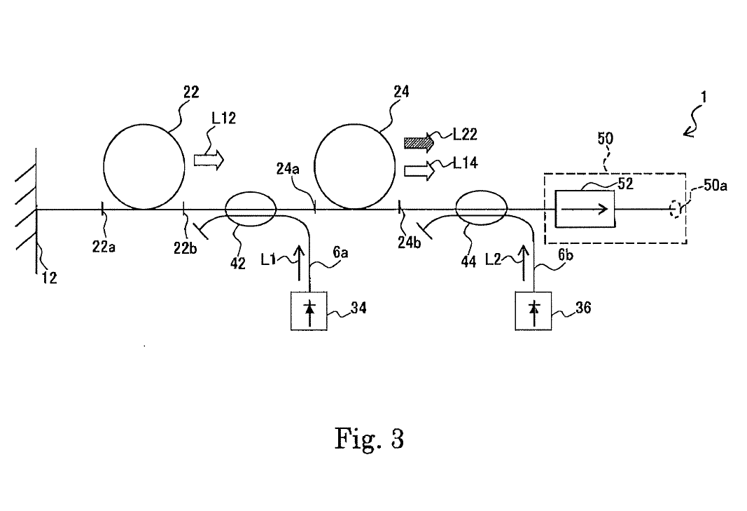

FIG. 3 is a diagram showing a configuration of the light source device 1 according to the third embodiment of the present invention. The light source device 1 according to the third embodiment includes the reflection end (light reflection means) 12, the first EDF bit spontaneously emitted light output means) 22, the second EDF (second spontaneously emitted light output means) 24, the first excitation light source 34, the second excitation light source 36, the first coupler (first connection means) 42, the second coupler (second connection means) 44, and integrated output means 50. In the following section, similar components are denoted by the same numerals as of the first embodiment, and will be explained in no more details.

The reflection end (light reflection means) 12, the first EDF (first spontaneously emitted light output means) 22, the second EDF (second spontaneously emitted light output means) 24, and the integrated output means 50 are the same as those of the first embodiment, and will not be explained.

The first excitation light source 34 is a light source which emits the first excitation light L1 with a wavelength of 980 nm. The second excitation light source 36 is a light source which emits the second excitation light L2 with a wavelength of 980 nm. If the power of the first excitation light L1 is represented as P1, and the power of the second excitation light L2 is represented as P2, it is assumed that P1<P2. Particularly, it is preferable that P1:P2=1:3 (P2/P1=3).

The first coupler 42 is approximately the same as that of the first embodiment, and a description will be given of differences. The first coupler 42 is connected to the first excitation light source 34 by a fiber 6a. The fiber 6a is different from a fiber to which the first EDF 22 and the second EDF 24 are connected.

The first coupler 42 leads the light (first spontaneously emitted light L12) output from the other end 22b of the first EDF 22 only to the one end 24a of the second EDF 24, and does not lead the light to the fiber 6a. Moreover, the first coupler 42 leads the first excitation light L1 input via the fiber 6a only to the other end 22b of the first EDF 22, and does not lead the first excitation light L1 to the one end 24a of the second EDF 24. The first coupler 42 is a WDM coupler, for example.

The second coupler 44 is approximately the same as that of the first embodiment, and a description will be given of differences. The second coupler 44 is connected to the second excitation light source 36 by a fiber 6b. The fiber 6b is different from the fiber to which the first EDF 22 and the second EDF 24 are connected.

The second coupler 44 leads the light (second spontaneously emitted light L14 and longer wavelength light L22) output from the other end 24b of the second EDF 24 only to the integrated output means 50. The second coupler 44 does not lead the light to the fiber 6b. Moreover, the second coupler 44 leads the second excitation light L2 input via the fiber 6b only to the other end 24b of the second EDF 24, and does not lead the second excitation light L2 to the integrated output means 50. The second coupler 44 is a WDM coupler, for example.

A description will now be given of an operation of the third embodiment.

The first excitation light source 34 first outputs the first excitation light L1. The first excitation light L1 is input to the first coupler 42 via the fiber 6a. The first coupler 42 leads the first excitation light L1 only to the other end 22b of the first EDF 22. The first excitation light L1 is thus input to the first EDF 22. Erbium ions contained in the first EDF 22 are excited to a higher energy level by the first excitation light L1. ASE (Amplified Spontaneous Emission) light is generated when the excited erbium ions transit to a lower energy level. The ASE light is “Amplified Spontaneous Emission” light, and is a type of spontaneous emission light. On this occasion, the spontaneous emission light generated in the first EDF 22 is referred to as the first spontaneously emitted light L12. The wavelength band of the first spontaneously emitted light L12 is the 1.55 μm band (C band).

The first spontaneously emitted light L12 is output from the other end 22b of the first EDF 22, and is input to the first coupler 42. The first coupler 42 leads the first spontaneously emitted light L12 only to the one end 24a of the second EDF 24.

The second excitation light source 34 outputs the second excitation light L2. The second excitation light L2 is input to the second coupler 44 via the fiber 6b. The second coupler 44 leads the second excitation light L2 only to the other end 24b of the second EDF 24. The second excitation light L2 is thus input to the second EDF 24. Erbium ions contained in the second EDF 24 are excited to a higher energy level by the second excitation light L2. ASE (Amplified Spontaneous Emission) light is generated when the excited erbium ions transit to a lower energy level. The ASE light is “Amplified Spontaneous Emission” light, and is a type of spontaneous emission light. On this occasion, the spontaneous emission light generated in the second EDF 24 is referred to as the second spontaneously emitted light L14. The wavelength band of the second spontaneously emitted light L14 is the 1.55 μm band (C band). The second spontaneously emitted light L14 is output from the other end 24b of the second EDF 24.

The first spontaneously emitted light L12 is output from the other end 22b of the first EDF 22, and is input to the first coupler 42. The first coupler 42 leads the first spontaneously emitted light L12 only to the one end 24a of the second EDF 24. The first spontaneously emitted light L12 is thus input to the second EDF 24. The second EDF 24 converts the input first spontaneously emitted light L12 into the longer wavelength light L22 with the longer wavelength, and outputs the longer wavelength light L22 from the other end 24b. The wavelength band of the longer wavelength light L22 is the 1.58 μm band (L band).

It should be noted that a part of the first spontaneously emitted light L12 may be output from the one end 22a of the first EDF 22. Moreover, a part of the second spontaneously emitted light L14 may be output from the one end 24a of the second EDF 24. In this way, the light progressing toward the reflection end 12 are reflected by the reflection end 12, and are converted into the longer wavelength light L22 after passing through the first EDF 22 and the second EDF 24.

As described above, the second spontaneously emitted light L14 and the longer wavelength light L22 are output from the end 24b of the second EDF 24. The second spontaneously emitted light L14 and the longer wavelength light L22 output from the other end 24b of the second EDF 24 are led only to the integrated output means 50 by the second coupler 44.

The integrated output means 50 outputs the second spontaneously emitted light L14 and the longer wavelength light L22 to the outside of the light source device 1. Apart of the second spontaneously emitted light L14 and the longer wavelength light L22 is reflected by the output end 50a, and tends to return to the second coupler 44. However, the isolator 52 prevents the reflected light from returning to the second coupler 44.

According to the third embodiment, the light source device 1 can simultaneously output the second spontaneously emitted light L14 (C band) and the longer wavelength light L22 (L band).

The embodiments have been described assuming that the reflection end 12 is connected to the one end 22a of the first EDF 22. However, non-reflection means, which does not return a light input from the one end 22a to the one end 22a, may be connected to the one end 22a.

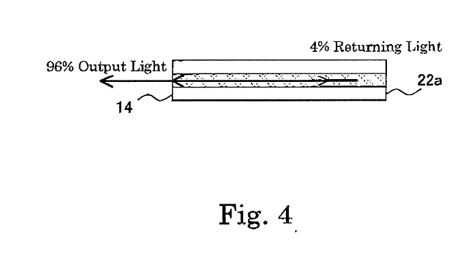

FIG. 4 is a diagram showing ratios of an output light and a returning light when the one end 22a of the first EDF 22 is connected to an open end. 96% of the light input from the one end 22a is output from the open end 14, and 4% thereof returns to the one end 22a. It should be noted that 96% and 4% respectively represent ratios of the intensity of the output light and the intensity of the returning light with respect to the intensity of the light input from the one end 22a.

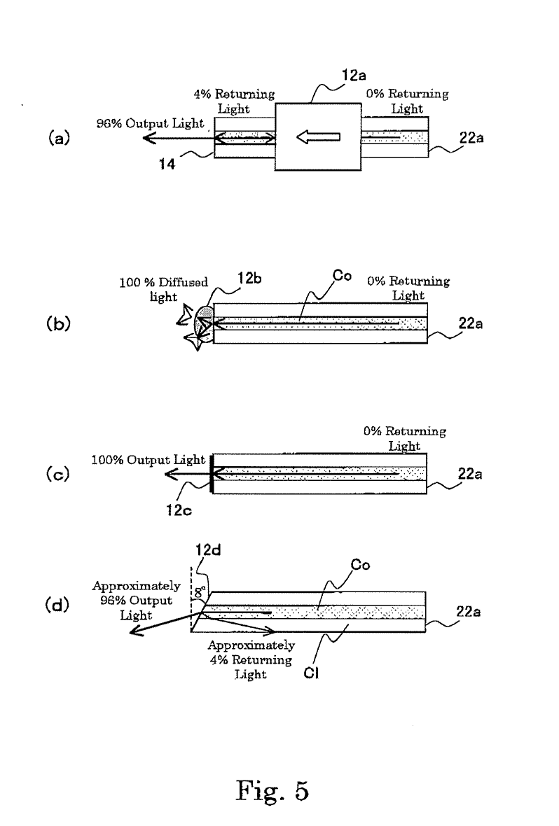

FIG. 5 is a diagram showing various non-reflection means (isolator 12a, matching jell 12b, AR coating 12c, and obliquely polished end 12d).

FIG. 5(a) is a diagram showing a case where the isolator 12a is connected to the one end 22a. Though 4% of the light input from the one end 22a is reflected by the open end 14, and tends to return to the one end 22a, the reflected light is blocked by the isolator 12a, and none of the reflected light returns to the one end 22a.

FIG. 5(b) is a diagram showing a case where the matching jell 12b is applied on the one end 22a, The matching jell 12b has the same refraction index as that of a core Co of the first EDF 22. 100% of the light input from the one end 22a is thus diffused in the matching jell 12b, and none of the light returns to the one end 22a.

FIG. 5(c) is a diagram showing a case where the one end 22a is coated by the AR coating 12c. The AR coating 12c is a non-reflection coating. 100% of the light input from the one end 22a is thus output through the AR coating 12c, and none of the light returns to the one end 22a.

FIG. 5(d) is a diagram showing a case where the obliquely polished end 12d is provided at an extreme end of the one end 22a. The obliquely polished end 12d is tilted by eight degrees with respect to the core Co of the first EDF 22. Approximately 4% of the light input from the one end 22a is reflected by the obliquely polished end 12d, and tends to return to the one end 22a. The incident angle of the reflected light is 8×2=16 degrees.

If the first EDF 22 is a single mode fiber, the NA (numerical aperture) of incident is usually 0.1. A light with an incident angle equal to or more than tan⁻¹(0.1)=5.7 degrees does not enter the core Co, and passes through to a clad portion Cl. Since approximately 4% of the reflected light does not enter the core Co, and passes through to the clad portion Cl, none of the reflected light returns to the one end 22a.

Moreover, reflection reduction means, which hardly returns the light input from the one end 22a to the one end 22a, may be connected to the one end 22a. “Hardly return” means that a light which returns to the one end 22a is negligibly small (0.04%, for example).

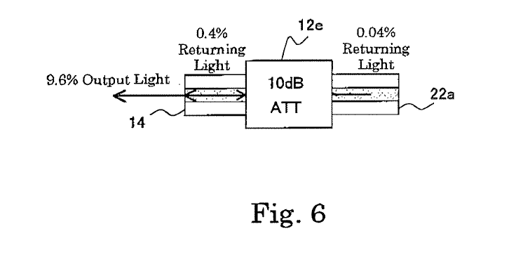

FIG. 6 shows the reflection reduction means (optical attenuator 12e). The optical attenuator 12e is connected to the one end 22a. The optical attenuator 12e is a 10 dB-attenuator, and the intensity of the light input from the one end 22a is attenuated to 10% thereof, and the attenuated light proceeds to the open end 14. Then, 9.6% of the light input from the one end 22a is output from the open end 14, and 0.4% thereof is reflected by the open end 14, and returns to the optical attenuator 12e. Then, the intensity of the reflected light of 0.4% is further attenuated to 10% thereof (namely, 0.4×0.1=0.04%) by the optical attenuator 12e, and the attenuated light returns to the one end 22a.

The reflection reduction means is not limited to the optical attenuator 12e, and an optical fiber with a large absorption or a very long fiber (loss is large due to the long length) may be used as the reflection reduction means.

Moreover, as shown in FIG. 4, the one end 22a of the first EDF 22 may be connected to the open end. Compared with the cases where the one end 22a is connected to the reflection end 12 or the non-reflection means, the cost can be reduced.

1. A light source device comprising:
a first spontaneously emitted light outputter that includes one end and the other end, and outputs a first spontaneously emitted light by means of a first excitation light input from the other end;
a second spontaneously emitted light outputter that includes one end connected to the other end of said first spontaneously emitted light outputter, and outputs a second spontaneously emitted light by means of a second excitation light input from the other end,
wherein said second spontaneously emitted light outputter converts the first spontaneously emitted light input from the one end to a longer wavelength light which has a longer wavelength, and outputs the longer wavelength light.

2. The light source device according to claim 1, comprising a light reflector that is connected to the one end of said first spontaneously emitted light outputter, and reflects a light input from the one end to the one end.

3. The light source device according to claim 1, comprising a non-reflector that is connected to the one end of said first spontaneously emitted light outputter, and does not return a light input from the one end to the one end.

4. The light source device according to claim 1, comprising a reflection reducer that is connected to the one end of said first spontaneously emitted light outputter, and hardly returns a light input from the one end to the one end.

5. The light source device according to claim 1, wherein the first spontaneously emitted light and the second spontaneously emitted light are within the C band, and said longer wavelength light is within the L band.

6. The light source device according to claim 1, comprising:
an integrated outputter that outputs the second spontaneously emitted light and the longer wavelength light;
a first excitation light generator that generates the first excitation light;
a first connector that connects said first excitation light generator and the other end of said first spontaneously emitted light outputter with each other;
a second excitation light generator that generates the second excitation light; and
a second connector that connects said second excitation light generator and the other end of said second spontaneously emitted light outputter, and said integrated output means outputter,
wherein said first connector leads the first excitation light to the other end of said first spontaneously emitted light outputter, and leads the first spontaneously emitted light to the one end of said second spontaneously emitted light outputter, and
said second connector leads the second excitation light to the other end of said second spontaneously emitted light outputter, and leads the second spontaneously emitted light and the longer wavelength light to said integrated outputter.

7. The light source device according to claim 1, comprising:
an integrated outputter that outputs the second spontaneously emitted light and the longer wavelength light;
an integrated excitation light generator that generates an integrated excitation light used as the first excitation light and the second excitation light;
a first connector that connects said integrated excitation light generator and the other end of said first spontaneously emitted light outputter with each other;
a second connector that connects said integrated excitation light generator and the other end of said second spontaneously emitted light outputter, and said integrated outputter,
wherein said first connector leads the integrated excitation light as the first excitation light to the other end of said first spontaneously emitted light outputter, and leads the first spontaneously emitted light to the one end of said second spontaneously emitted light outputter, and
said second connector leads the integrated excitation light as the second excitation light to the other end of said second spontaneously emitted light outputter, and leads the second spontaneously emitted light and the longer wavelength light to said integrated outputter.

8. The light source device according to claim 7, wherein said first connector is connected to said integrated excitation light generator via the second connector.

9. The light source device according to claim 7, comprising a third connector that connects said first connector, said second connector and said integrated excitation light generator.

10. The light source device according to claim 6, wherein the power of the second excitation light is larger than the power of the first excitation light.

11. The light source device according to claim 10, wherein the ratio of the power P2 of the second excitation light to the power P1 of the first excitation light: P2/P1 is 3.

12. The light source device according to claim 6, wherein said integrated outputter includes an isolator.

13. The light source device according to claim 6, wherein said second connector leads the second spontaneously emitted light and the longer wavelength light only to said integrated outputter.
